(19) United States
(12) Patent Application Publication
(10) Pub. No.: US 2001/0027444 A1
(43) Pub. Date: Oct. 4, 2001

(54) Member card administration system using a rewritable card, method therefor, and recording medium recorded with program therefor

(75) Inventor: Shusaku Mitsuhashi, Tokyo (JP)

Correspondence Address: David A. Blumenthal, FOLEY & LARDNER, Suite 500, 3000 K Street, N.W., Washington, DC, 20007-5109, US

(73) Assignee: NEC CORPORATION

(21) Appl. No.: 09/824,246

(22) Filed: Apr. 3, 2001

(30) Foreign Application Priority Data
Apr. 4, 2000 (JP) 2000-102159

(51) Int. Cl. G06F 17/60

(52) U.S. Cl. 705/64

(57) ABSTRACT

In a member card administration system which uses a rewritable card, and which makes common, service cards of a shop which has become a member, and which enables setting of services independently for each shop, a client administrative server 101 is provided with a communication section 1 for sending and receiving data related to a client via a computer network 104, and a client response recognition section 2 for recognizing access to the client administrative server 101 and judging the operation content contained in the received data, and distributing this to each section. Furthermore, there is provided a private information administration section 4 for recording and administering private information of a client received by the communication section 1, in a private information DB 3, a purchase history administration section 6 for recording in a purchase history DB 5, purchase history information of a client, a service point administration section 8 for recording and administering service point information of a client in a service point DB 7, and a service information administration section 10 for recording and administering service information of a shop in a service information DB 9.

### BACKGROUND OF THE INVENTION

1. Field of the Invention

The present invention relates to a member card administration system which uses a rewritable card for supporting unified administration of a privilege service for clients of a plurality of shops, and to a method, and a recording medium recorded with a program therefor.

2. Description of the Related Art

Heretofore, shops and outlets such as rental video, cleaning, beauty parlors, and supermarkets, issue service cards such as paper or magnetic cards for granting a service to clients by a system in accordance with unique rules. More specifically, each shop has a system which attaches a number of points called stamps or points to a service card in accordance with the purchased amount of a service or product which a client has bought, and depending on the total number of these stamps or the total number of points, performs for example a preferential sale or price discount service for the products, thereby encouraging a client to revisit the same shop or a related shop.

However, the granting of such a service unique to a shop is extremely troublesome since when seen from the client side, the client has a plurality of service cards for each shop, and each time these must be used properly. Furthermore, there is the problem that due to the loss of a card they may not receive a service to which they are entitled. Furthermore, since the client must disclose to a plurality of shops their private information such as their address, name, age and telephone number, the risk of this leaking out to another party is serious.

At the same time, when seen from the shop side, there is the problem that the aforementioned work load for the client is undesirable from the point of client satisfaction, thus conflicting with the service for encouraging the client to revisit the shop itself or a related shop.

### SUMMARY OF THE INVENTION

The present invention takes into consideration the abovementioned problems, with the object of providing a member card administration system which supports unified administration of a privilege service for clients of a plurality of shops. More specifically, it is an object of the present invention to provide a member card administration system which uses a rewritable card, and which makes common, service cards of a shop which joins a member card administration system by means of a rewritable card, and which enables setting of the service contents independently for each shop, and a method, and a recording medium recorded with a program therefor.

To address the above problems, the present invention is a client administrative server used in a member card administration system which uses a rewritable card, and is characterized comprising; a communication device for sending and receiving data via a computer network, a private information administration device for recording and administering in a private information database, private information of clients containing client ID, contained in data received by the communication device, and a service point administration device for relating service point information of clients contained in data received by the communication device to client information and shop information, and recording and administering this in a service point database.

With the above construction, private information of a client, and the service points of the client can be administered together as one.

The present invention, is characterized in that in the client administrative server, there is provided a purchase history administration device for relating purchase history information of clients contained in data received by the communication device to client information and recording and administering this in a purchase history database.

With the above construction, the preferences and lifestyle of a client can be understood from the information accumulated in the client administrative server.

The present invention, is characterized in that in the client administrative server, there is provided a service information administration device for relating service information of shops contained in data received by the communication device to shop information, and recording and administering this in a service information database.

With the above construction, service information for each shop can be efficiently provided to the client.

The present invention, is characterized in that in the client administrative server, there is provided a service information generation device for selecting recorded contents of the service information database using product information stored in the purchase history database, and creating and transmitting service information for each client to an address recorded in the private information database.

With the above construction, service information combined with client preferences or lifestyle can be automatically sent to the client.

The present invention is characterized in that in the client administrative server, the private information administration device compares a client password contained in data received by the communication device with a client password recorded in the private information database, with respect to a reissue command for a service card, and in the case where both match, transmits a reissue permit command.

With the above construction, if the client acquires only a rewritable card, it is possible to reissue a service card.

The present invention is characterized in that a shop terminal is connectable by communication to any of the abovementioned client administrative servers, and comprises; a communication device for sending and receiving data via a computer network, a data input device for inputting information of client ID and password to a user, a purchased product input device for inputting information of products which a client has bought to a user, a service rule administration device for administering information showing a proportion of points to purchased amount recorded in a service rule database, a purchase history creation device for creating purchase history information of products which a client has bought from product information input to the purchased product input device, a point information creation device for creating service point information corresponding to the purchased amount of products which a client has bought, based on the proportion of points to purchased amount recorded in the service rule database, and a client administration device for sending together with the client ID and password, the purchase history information and the service point information, and also shop ID by means of the communication device.

With the above construction, a member shop can accumulate and administer service point information or purchase history information of a client in a client administrative server.

The present invention is characterized in that in the shop terminal there is provided a card read and write device capable of reading out a client ID from the rewritable card at the time of service card use, and writing a client ID to the rewritable card at the time of service card reissue.

With the above construction, a member shop can easily perform issue and administration of client service cards.

The present invention is characterized in that in the shop terminal there is provided a client information retrieval device for transmitting a client information retrieve command by the communication device, and receiving replied client information and recording this in a client information recording file.

With the above construction, a member shop can acquire information of a client freely from the client administrative server.

The present invention is characterized in that a user terminal is connectable by communication to any of the abovementioned client administrative servers, and comprises; a communication device for sending and receiving data via a computer network, a data input device for inputting information of client ID or password to a user, a use state retrieval device for sending a use state retrieve command together with the client ID or password, and receiving a replied use state, and recording this in a use state recording file, and a service information retrieval device for sending a service information retrieve command together with the client ID or password, and receiving replied service information, and recording this in a service information recording file.

With the above construction, a client can acquire the use state of their own service points, or service information for each shop, freely from the client administrative server.

The present invention is characterized in that in the user terminal, instead of the data input device, there is provided a card read and write device capable of reading out a client ID from the rewritable card at the time of service card use, and writing a client ID to the rewritable card at the time of service card reissue.

With the above construction, a client can perform an operation with respect to the service card, even if outside of the shop of a member shop.

The present invention is a member card administration system which uses a rewritable card, connected via a computer network, and is characterized in containing; any of the abovementioned client administrative servers, any of the abovementioned shop terminals, and any of the abovementioned user terminals.

With the above construction, a member card administration system which is not limited to location or type of business can be constructed.

The present invention is a member card administration method which uses a rewritable card and is characterized in that a client administrative server side contains; a communication process for sending and receiving data via a computer network, a process for recording and administering private information of clients which contains client ID, contained in data received by the communication device, in an private information database, and a process for relating service point information of clients contained in data received by the communication device to client information and shop information, and storing and administering this in a service point database,

and a shop terminal side contains; a communication process for sending and receiving data via a computer network, a process for inputting information of client ID and password to a user, a process for inputting information of products which a client has bought to a user, a process for administering information showing a proportion of points to purchased amount stored in a service rule database, a process for creating purchase history information of products which a client has bought from product information input to the purchased product input device, a process for creating service point information corresponding to purchased amount of products which a client has bought based on a proportion of points to purchased amount recorded in the service rule database, and a process for sending together with the client ID and password, the purchase history information and the service point information, and also shop ID,

and a user terminal side contains; a communication process for sending and receiving data via a computer network, a process for inputting information of client ID or password to a user, a process for sending a use state retrieve command together with the client ID and password, and receiving a replied use state and recording this in a use state recording file, and a process for sending a service information retrieve command together with the client ID or password, and receiving replied service information and recording this in a service information recording file.

The present invention is a computer readable recording medium recorded with a program for a client administrative server side used in member card administration which uses a rewritable card, and is characterized in that the program comprises: a communication process for sending and receiving data via a computer network, a process for recording and administering private information of clients which contains client ID, contained in data received by the communication device, in a private information database, and a process for relating service point information of clients contained in data received by the communication device to client information and shop information, and recording and administering this in a service point database.

The present invention is a computer readable recording medium recorded with a program for a shop terminal side used in member card administration which uses a rewritable card, and is characterized in that the program comprises: a communication process for sending and receiving data via a computer network, a process for inputting information of client ID and password to a user, a process for inputting information of products which a client has bought to a user, a process for administering information showing a proportion of points to purchased amount recorded in a service rule database, a process for creating purchase history information of products which a client has bought from product information input to the purchased product input device, a process for creating service point information corresponding to the purchased amount of products which a client has bought, based on the proportion of points to purchased amount recorded in the service rule database, and a process for sending together with the client ID and password, the purchase history information and the service point information, and also shop ID.

The present invention is a computer readable recording medium recorded with a program for a user terminal side used in member card administration which uses a rewritable card, and is characterized in that the program comprises: a communication process for sending and receiving data via a computer network, a process for inputting information of client ID or password to a user, a process for sending a use state retrieve command together with the client ID or password, and receiving a replied use state and recording this in a use state recording file, and a process for sending a service information retrieve command together with the client ID or password, and receiving replied service information and recording this in a service information recording file.

### BRIEF DESCRIPTION OF THE DRAWINGS

FIG. 1 is a block diagram showing a configuration of a client administrative server according to an embodiment of the present invention.

FIG. 2 is a flow chart for explaining an operation related to card issue, of the client administrative server of the embodiment.

FIG. 3 is a flow chart for explaining an administration operation of purchase history information, of the client administrative server of the embodiment.

FIG. 4 is a flow chart for explaining an administration operation for service information, of the client administrative server of the embodiment.

FIG. 5 is a flow chart for explaining an automatic issue operation for service information, of the client administrative server of the embodiment.

FIG. 6 is a block diagram showing a configuration of a shop terminal according to an embodiment.

FIG. 7 is a flow chart for explaining an operation concerning card issue of a shop terminal according to the embodiment.

FIG. 8 is a flow chart for explaining an administration operation of client history information of a shop terminal of the embodiment.

FIG. 9 is a block diagram showing a configuration of a user terminal according to an embodiment.

FIG. 10 is a flow chart for explaining a retrieve operation of the user terminal of the embodiment.

FIG. 11 is a diagram for explaining an overall configuration example of a member card administration system of the embodiments.

### DETAILED DESCRIPTION OF THE INVENTION

Hereunder is a description of embodiments of the present invention with reference to the drawings.

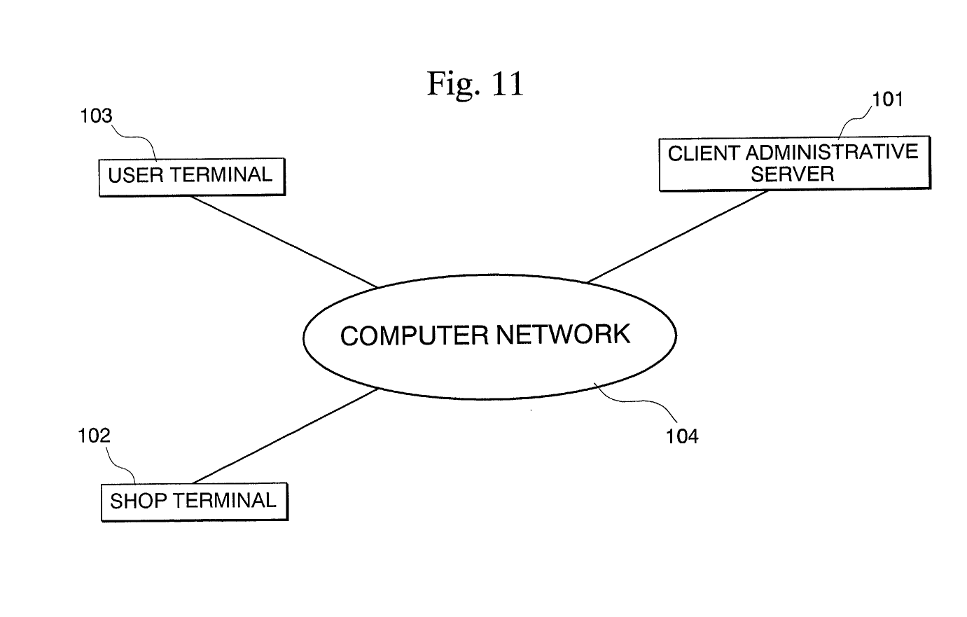

At first, the overall construction of a member card administration system is described. FIG. 11 is a diagram explaining the overall construction of the member card administration system.

In FIG. 11, a client administrative server 101 administers private information such as the address, name, client ID of a client, purchase history such as the product contents bought by a client and the purchased amount, information on points granted to a client, and information related to rules for services of each shop or related to privileges of each shop.

A shop terminal 102 is placed in a member card administration system member shop, and is used in new registration processing of a client, or in registration processing for product purchase history and points granted to a client. The shop terminal 102 calculates service points to grant to a client in accordance with the purchased amount of services or products which a client purchases. The granted service points are administered on the client administrative server 101, and if the client merely shows a client ID and password, the client can freely use the service points. Since the service contents for the service points can be freely set for each shop of the member shops, a detailed description will not be given here. In general, this is a service for discounting the purchased amount by the service point portion.

Furthermore, a user terminal 103 is used for confirming points granted or changes in private information, and for receiving offers of privilege service information at each shop, by the client accessing the client administrative server 101. For the user terminal 103, an exclusive terminal may be placed in a member shop, or a PC terminal in the client's house may be used.

These system components are connected to a computer network 104 within a member card administration system, so that exchange of data between these is freely performed. Here, “computer network” is a network such as the Internet, or a public line, which can be connected by communication between computers, and a combination of these networks.

Next is a detailed description related to each of the above system components, with reference to the drawings. The description will first be given from the client administrative server 101.

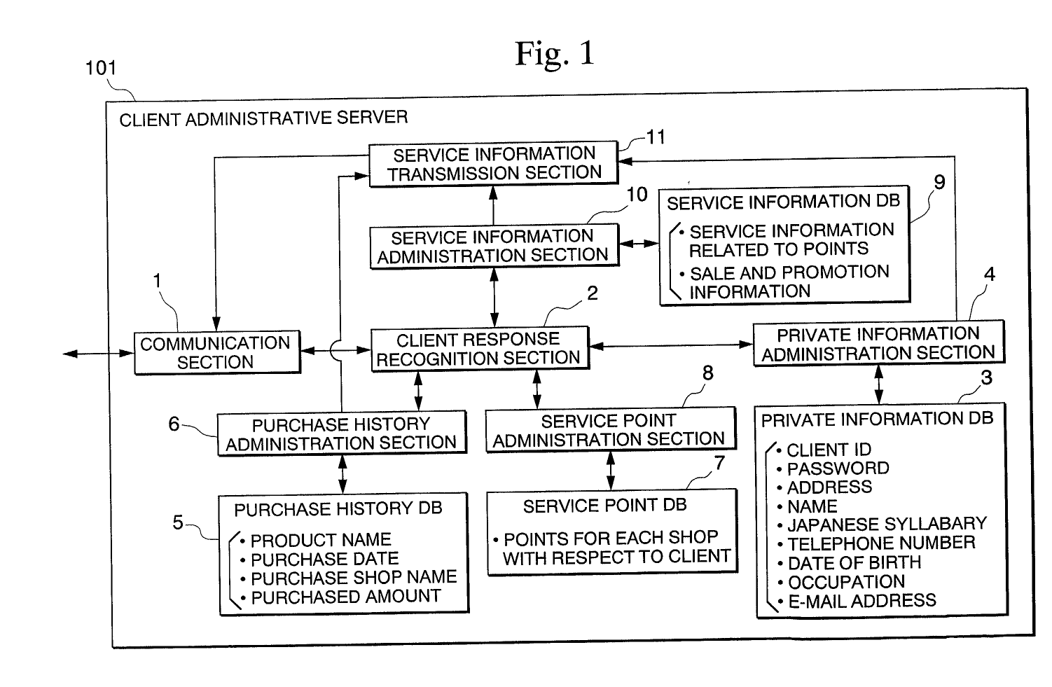

FIG. 1 is a block diagram showing a configuration of the client administrative server 101. In FIG. 1, the client administrative server 101 is provided with a communication section 1 for sending and receiving data related to a client via the computer network 104, and a client response recognition section 2 for recognizing access to the client administrative server 101 via the communication section 1, and judging the operation content contained in the received data, and distributing this to each section.

Furthermore, there is provided a private information administration section 4 for recording and administering private information of a client contained in the data received by the communication section 1, in a private information DB (database) 3, a purchase history administration section 6 for recording in a purchase history DB (database) 5, purchase history information of a client which is contained in the same received data, a service point administration section 8 for recording and administering service point information of a client in a service point DB (database) 7, and a service information administration section 10 for recording and administering service information of a shop in a service information DB (database) 9.

Moreover, there is provided a service information transmission section 11 which selects the contents of the service information DB 9 using the contents of the purchase history DB 5, and creates and transmits service information for each client to an address recorded in the private information DB 3.

Next is a description of the operation of the client administrative server 101, with reference to the figures. The client administrative server 101 has the following eight functions.

(1) New card issue.

(2) Card reissue.

(3) Card use information registration.

(4) Use state retrieval from a client.

(5) Client information retrieval from a shop.

(6) Registration of service information from a shop.

(7) Retrieval of service information from a client.

(8) Transmission of service information to a client.

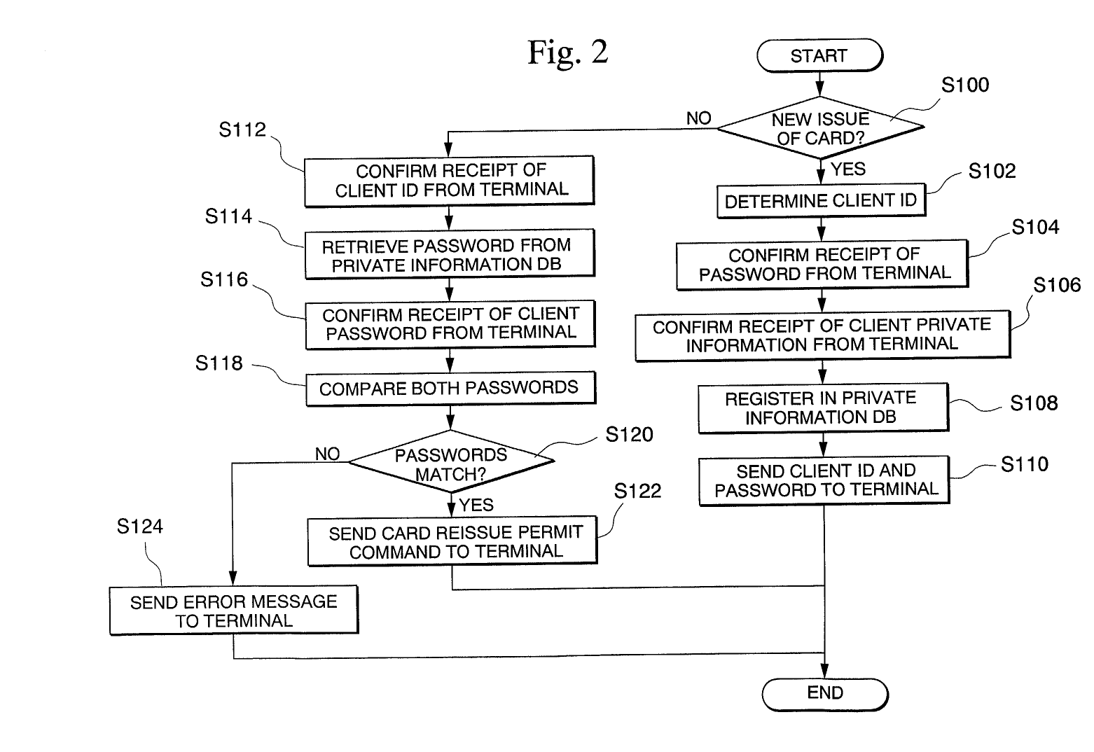

FIG. 2 is a flow chart for explaining an operation related to card issue, of the client administrative server 101, describing the functions of the abovementioned (1) and (2).

The client response recognition section 2, on receipt of an issue command for a card, judges if this is for new issue of a card (step S100).

If the command is for the new issue of a card (step S100: YES), the private information administration section 4 determines the client ID of the client desiring card issue (step S102).

Once the client ID is determined, receipt of a password input from the terminal is confirmed (step S104), and then in a similar manner, receipt of private information of the client input from the terminal is confirmed (step S106). Here the private information includes for example; the address, name, Japanese syllabary, telephone number, date of birth, occupation, e-mail address, and so forth.

If in the received password and private information there are no defects such as the use of unavailable characters, or omissions, the private information administration section 4 registers both in the private information DB 3 on the basis of the client ID (step S108). Then, the registered password and client ID are sent to the terminal requesting card issue, and control ends (step S110).

Furthermore, in the case where the command in step S100 is for the reissue of a card (step S100: NO) the client response recognition section 2 confirms the client ID input from the terminal (step S112), and the private information administration section 4 retrieves a password corresponding to this client ID from the private information DB 3 (step S114).

Next, receipt of the password input from the terminal is confirmed (step S116).

Then, a comparison is made of the password input from this terminal with the password retrieved from the private database (step S118).

If on comparison both passwords are the same (step S120: YES), a card reissue permit command is sent to the terminal requesting card reissue, thus completing the operation (step S122).

If on comparison, the two passwords are not the same (step S120: NO), the private information administration section 4 sends an error message to the terminal requesting card reissue, and control ends (step S124).

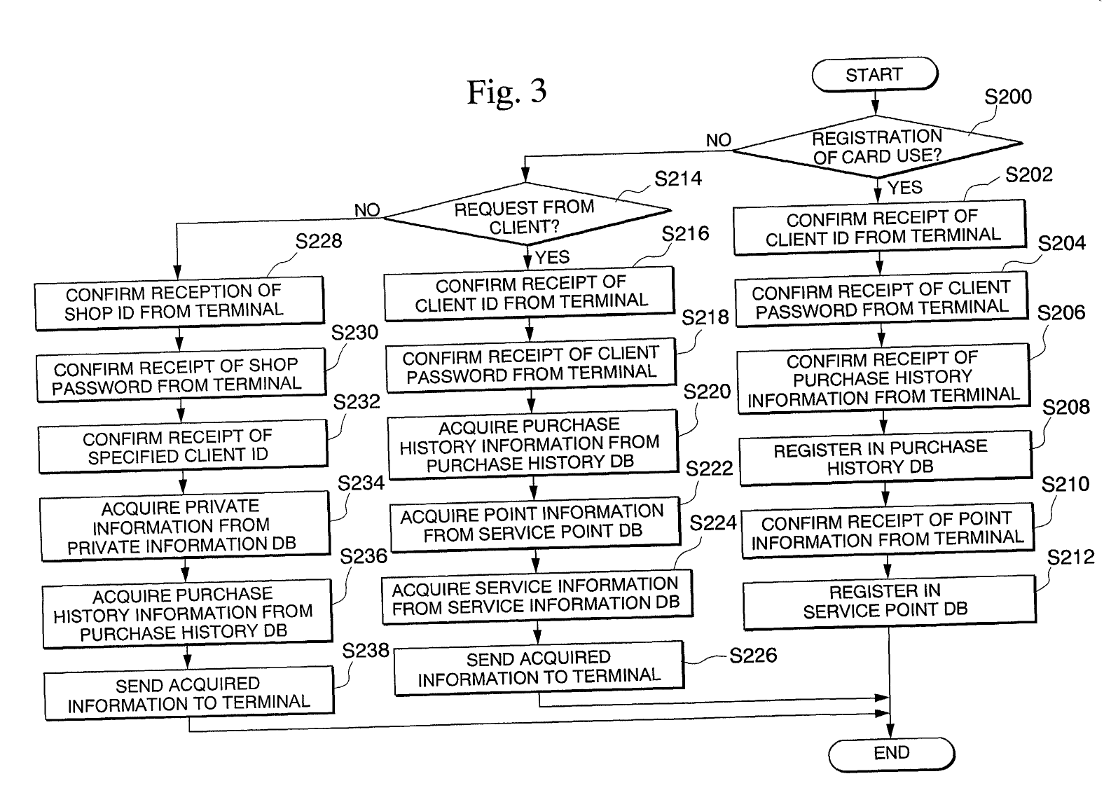

FIG. 3 is a flow chart for explaining an administration operation for the purchase history information, of the client administrative server 101, describing the functions of the abovementioned (3), (4) and (5).

The client response recognition section 2 at first judges if a command is for registration of card use (step S200).

If the command is for registration of card use (step S200: YES), receipt of a client ID from the terminal is confirmed (step S202).

Then, receipt of a client password is confirmed (step S204).

If the password can be confirmed, at first the purchase history administration section 6 receives purchase history information of the client (step S206).

The purchase history administration section 6 registers received purchase history information in the purchase history DB 5 on the basis of the client ID (step 208).

Since in the received data there is inserted service point information following the purchase history information, then the service point administration section 8 receives the service point information (step S210).

Next, the service point administration section 8 registers in the service point DB 7 in a two dimensional array of the client ID and the shop ID, the received service point information, and control ends (step S212).

Furthermore, in the case where the command in step S200 is not for card use registration (step S200: NO), the client response recognition section 2 judges if the command is a retrieve command from the client (step S214).

If the command is a retrieve command from the client (step S214: YES), receipt of the client ID from the terminal is confirmed (step 216).

Next, receipt of the client password is confirmed (step S218).

Then, the purchase history administration section 6 retrieves and acquires purchase history information from the purchase history DB 5 corresponding to the received client ID (step S220).

Similarly, the service point administration section retrieves and acquires point information from the service point DB 7 corresponding to the received client ID (step S222).

Then, the service information administration section 10 acquires all of the privilege information for the user of the member shop which is registered in the service information DB 9 (step S224), and the client response recognition section 2 sends this together with the purchase history information and the point information to the client terminal which has requested the retrieval, and control ends (step S226).

Furthermore, in the case where the command is not a retrieve command from the client (step S214: NO), the client response recognition section 2 assumes receipt of a client information retrieve command from a member shop, and confirms receipt of the shop ID from the terminal (step S228). Next, receipt of the password of the shop is confirmed (step S230).

Then receipt of client ID which the shop specifies is confirmed (step S232).

Once the specified client ID is confirmed, the private information administration section 4 acquires private information corresponding to the specified client ID from the private information DB 3 (step S234).

Similarly, the purchase history administration section 6 acquires purchase history information corresponding to the specified client ID from the purchase history DB 5 (step S236).

Then, the client response recognition section 2 sends this together with the private information and the purchase history information to the terminal which requested the client information retrieval, and control ends (step S238).

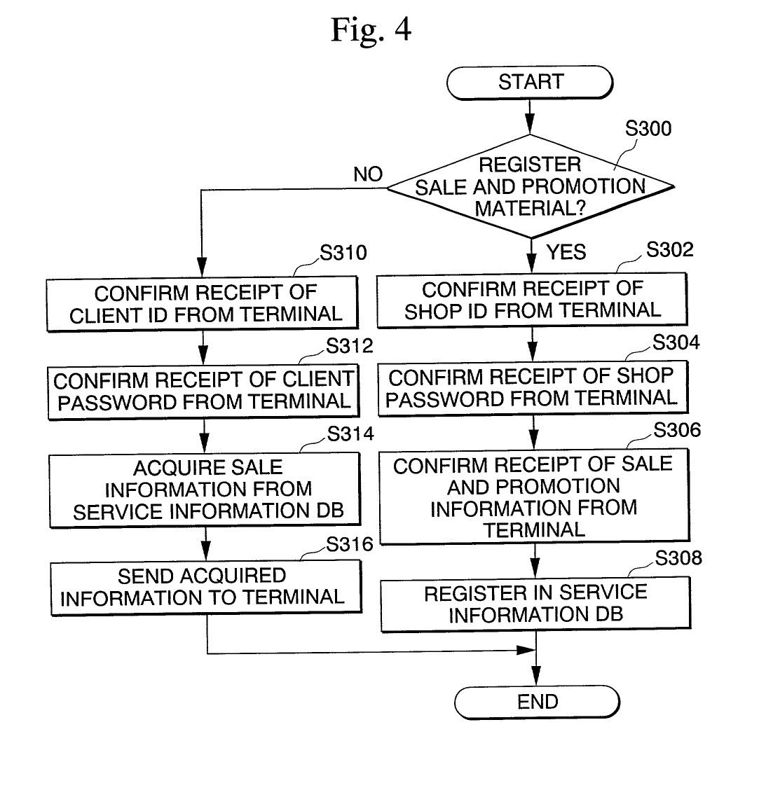

FIG. 4 is a flow chart for explaining the administration operation for the service information, of the client administrative server 101, describing the functions of the abovementioned (6) and (7).

The client response recognition section 2 at first judges if a command is for registration of sales and promotion information (step S300).

If the command is for registration of sales and promotion information (step S300: YES), receipt of the shop ID from the terminal is confirmed (step S302), and then the password of the shop is confirmed (step S304).

Then, the service information administration section 10 confirms receipt of the sales and promotion information of the shop indicated by the shop ID from the terminal (step S306).

Next, the service information administration section 10, with the shop ID as a reference, registers the received sales and promotion information in the service information DB 9, and control ends (step S308).

Furthermore, in the case where the command in step S300 is not for registration of sales and promotion information (step 300: NO), the client response recognition section 2 assumes receipt of a service information retrieve command from the client, and confirms receipt of the client ID from the terminal (step 310), and then confirms the password of the client (step S312).

Next the service information administration section 10 acquires all of the sales and promotion information of the member shop recorded in the service information DB 9 (step S314).

Then, the client response recognition section 2 sends the acquired sales and promotion information to the terminal which has requested retrieval of the service information (step S316).

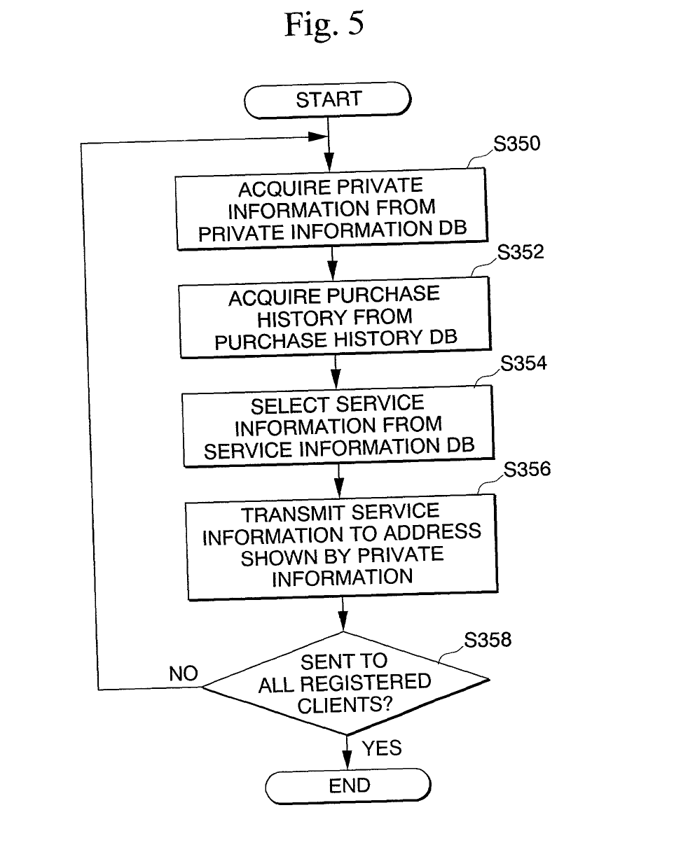

FIG. 5 is a flow chart for explaining an automatic issue operation for service information, of the client administrative server 101, describing the function of the abovementioned (8).

The service information transmission section 11 at first acquires private information for one registered client at a time, from the private information DB 3, via the private information administration section 4 (step S350).

Similarly, this acquires the purchase history information for the same client ID as for the acquired private information, from the purchase history DB 5, via the purchase history administration section 6 (step S352).

Next, the service information transmission section 11 selects and acquires service information for the item determined by the purchase history information for that client, from the service information DB 9, via the service information administration section 10 (step S354).

Then, the service information transmission section 11 transmits the acquired service information to the address of the acquired private information (step S356). In this case, for transmission of the information, for example transmission by electronic mail, or printing a message and an address for direct mail is considered.

The service information transmission section 11 judges if the information for all the registered clients has been transmitted (step S358), and if transmission has not been made to all clients (step S358: NO), control returns to step S350 and the same process is repeated until service information has been transmitted to all clients.

If the service information has been transmitted to all clients (step S358: YES), the operation ends.

Next is a description of the shop terminal 102 of the member card administration system.

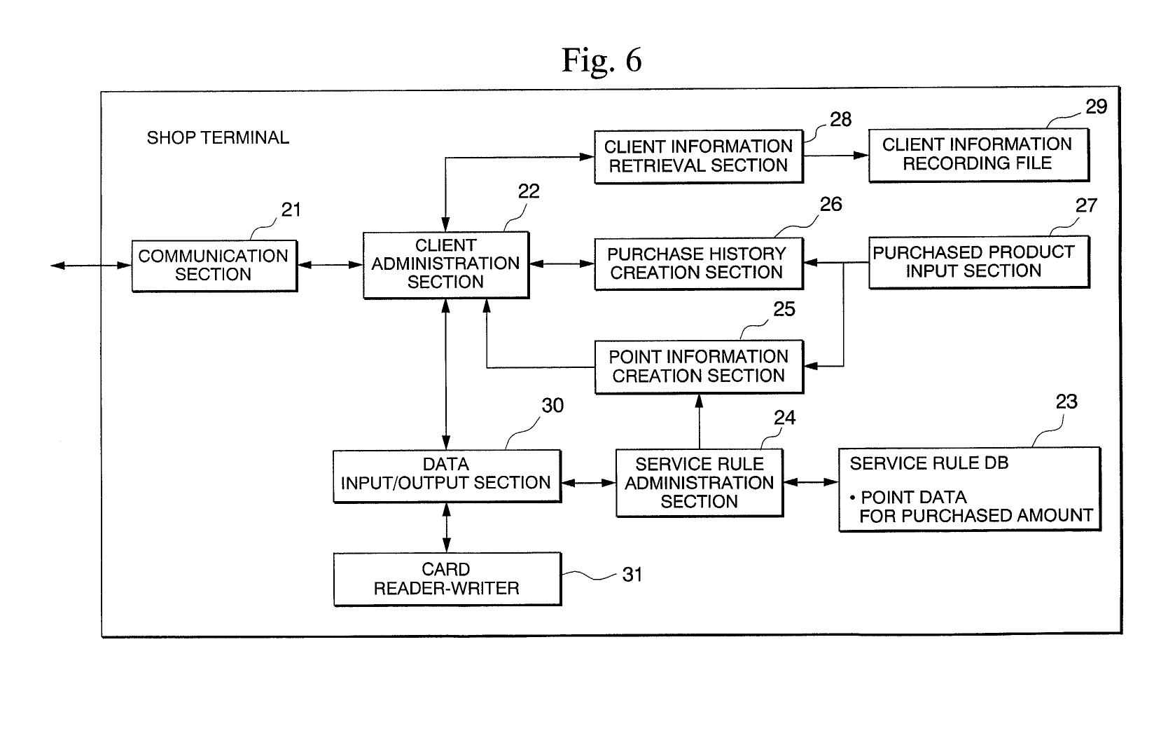

FIG. 6 is a block diagram showing the configuration of the shop terminal 102. In FIG. 6, the shop terminal 102 is provided with; a communication section 21 for transmitting and receiving data related to clients via the computer network 104, a client administration section 22 for collecting data related to the clients, a purchase history creation section 26 for creating and inserting history of products which a client has bought, to data for transmission through the client administration section 22, and a point information creation section 25 for similarly creating and inserting service point information corresponding to the purchased amount of products which a client has bought, to data for transmission.

Furthermore, the point information creation section 25 is provided with a service point administration section 24 for supplying information showing the proportion of points to purchased amount to a service rule DB 23, and a purchased product input section 27 for inputting information of products which the client has bought to the purchase history creation section 26 and the point information creation section 25.

Furthermore, there is provided a data input/output section 30 for inserting information on client ID or password to the data for transmission through the client administration section 22, and inputting data to the service point administration section 24, and a card reader-writer 31.

Next is a description of the operation of the shop terminal 102, with reference to the drawings. The shop terminal 102 has the following five functions.

(1) New card issue.

(2) Card reissue.

(3) Card use information registration.

(4) Client information retrieval from a shop.

(5) Registration of service information from a shop.

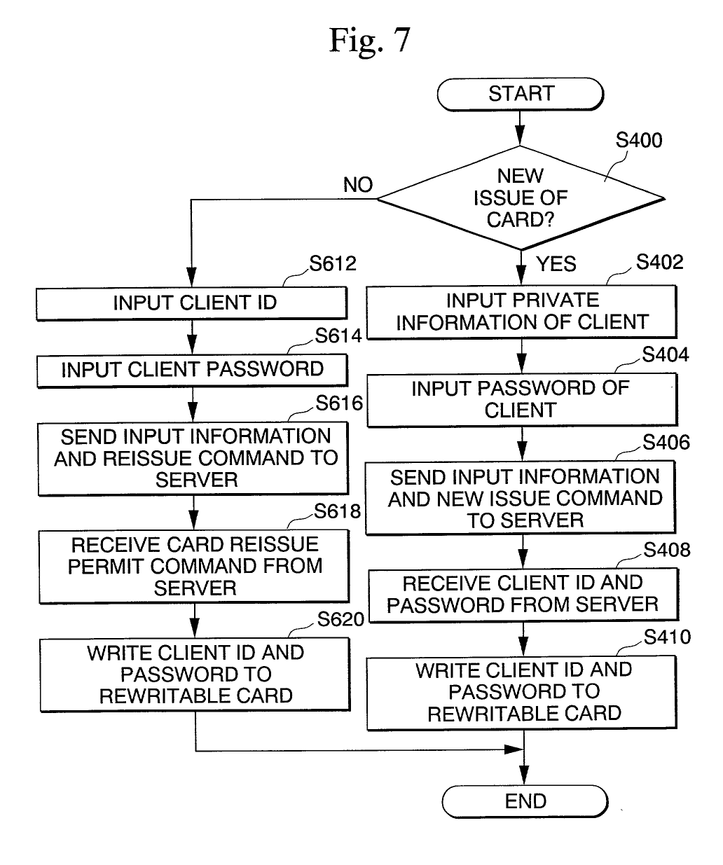

FIG. 7 is a flow chart for explaining an operation related to card issue, of the shop terminal 102, describing the functions of the abovementioned (1) and (2).

The client administration section 22, on receipt of a card issue request, judges if this is for a new issue of a card (step S400).

If the request is for a new issue of a card (step S400: YES), private information of the client desiring the card reissue is input (step S402).

Once the private information of the client has been input, then following this the password of the client is input (step S404).

Next, the client administration section 22 sends the input information and the command for the new issue of the card to the client administrative server 101 through the communication section 21 (step S406).

If as a response to this, the client ID and password are received from the client administrative server 101 (step S408), the client administration section 22 writes the client ID and password to the rewritable card by means of the card reader-writer 31, through the data input/output section 30 (step S410).

Furthermore, in the case where the request in step S400 is for a card reissue (step S400: NO), the client administration section 22 inputs the client ID of the client desiring card reissue (step S412).

Next, the password of the client is input (step S414), and similarly, input information and a card reissue command are sent to the client administrative server 101 through the communication section 21 (step S416).

If as a response to this, the client ID and password are sent from the client administrative server 101 (step S418), the client administration section 22 writes the client ID and password to the rewritable card by means of the card reader-writer 31, and control ends (step S420).

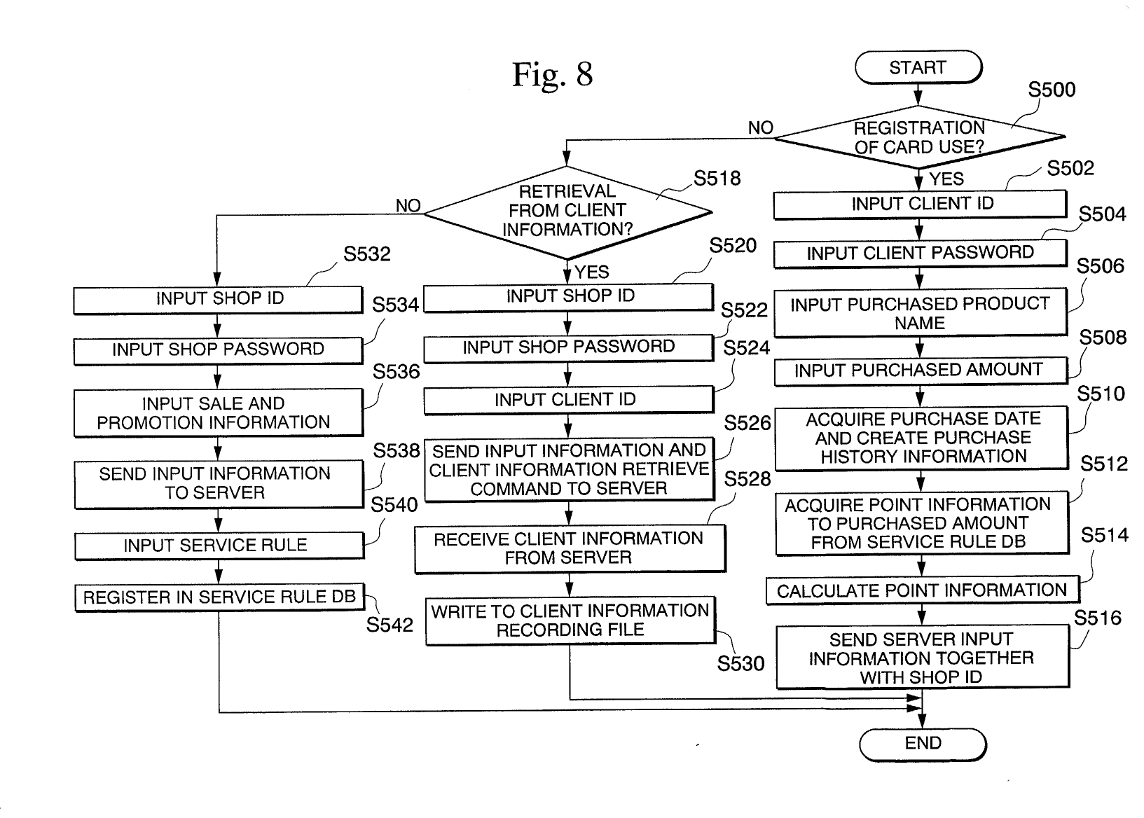

FIG. 8 is a flow chart for explaining an administration operation for the purchase history information, of the shop terminal 102, describing the functions of the abovementioned (3), (4) and (5).

The shop terminal 102 at first judges if a request is for registration of card use (step S500).

If the request is for registration of card use (step S500: YES), the client administration section 22 inputs the client ID of the client desiring card use registration (step S502).

Next, the password of the client is input (step S504).

Then, the name of the product which that client has bought is input from the purchased product input section 27 (step S506).

Similarly, the purchased amount of that product is input (step S508).

On the other hand, the purchase history creation section 26 acquires as the purchase date, the date for the point in time when the product name and purchased amount are input, and combines together the abovementioned purchased product name and purchased amount, and the purchase shop name, to create the purchase history information (step S510).

Furthermore, the point information creation section 25 acquires the points to purchased amount from the service rule DB 23 (step S512), and calculates how many points to give to that client for the input purchased amount (step S514).

Once the points to be given have been calculated, the client administration section 22 sends all of the above data with the shop ID attached, and the registration command for card use, to the client administrative server 101, and control ends (step S516).

Furthermore, in the case where the request in step S500 is not for registration of card use (step S500: NO), the client administration section 22 judges if the request is for retrieval of client information (step S518). If the request is for retrieval of client information (step S518: YES), the client administration section 22 at first inputs the ID of the shop (step S520).

Next, the password of the shop is input (step S522).

Furthermore, the client ID of the client desiring retrieval is input (step S524).

Once the ID of the client desiring retrieval has been determined, a client information retrieval section 28 sends all of the above data and the client information retrieve command to the client administrative server 101 through the client administration section 22 (step S526).

If as a response to this, the client information is received from the client administrative server 101 (step S528), the client administration section 22 records the received client information in a client information recording file 29 through the client information retrieval section 28, and control ends (step S530).

Furthermore, in the case where the request is not for retrieval of client information (step S518: NO), the client administration section 22 assumes a request for registration of service information of the member shop, and inputs the ID of the shop (step S532).

Next, the password of the shop is input (step S534).

Then, sale and promotion information of the shop is input (step S536).

Once the sale and promotion information has been input, the client administration section 22 sends all of the above data and the registration command for the service information to the client administrative server 101 (step S538).

Next, the service point administration section 24 inputs a service rule showing the relation of the service points to purchased amount peculiar to that shop (step S540).

The service point administration section 24 registers the input service rule in the service rule DB 23, and control ends (step S542).

Next is a description of the user terminal 103 of the member card administration system.

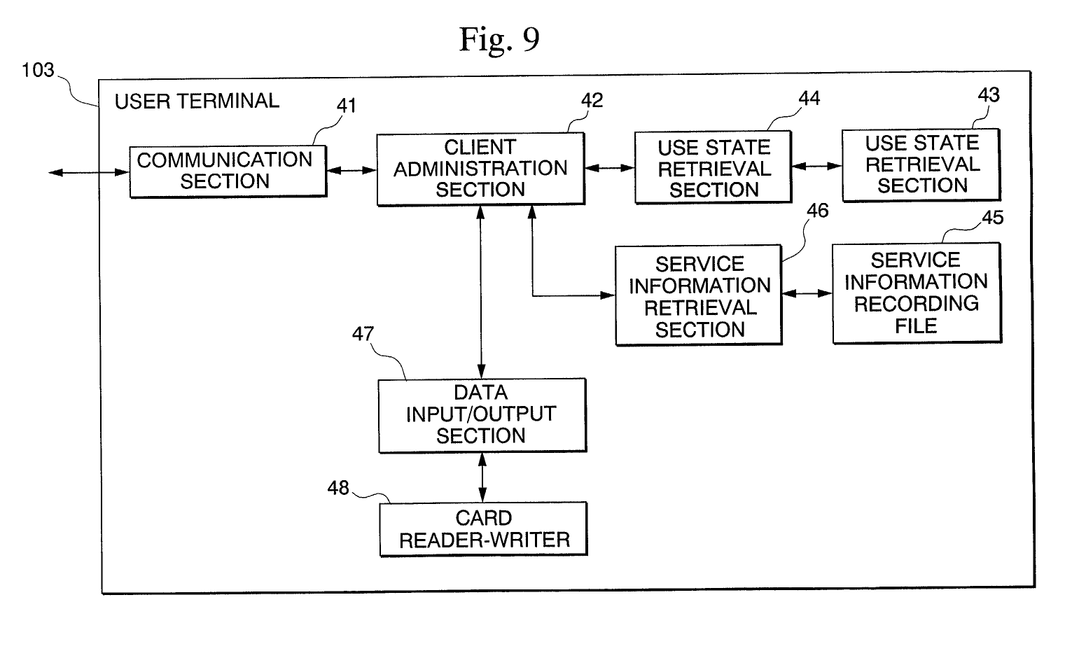

FIG. 9 is a block diagram showing the configuration of the user terminal 103. In FIG. 9, the user terminal 103 is provided with; a communication section 41 for sending and receiving data related to clients via the computer network 104, a client administration section 42 for arranging data related to these clients, a use state retrieval section 44 for sending a use state retrieve command through the client administration section 42, and receiving the replied use state and recording this in a use state recording file 43, and a service information retrieval section 46 for similarly sending a service information retrieve command, and receiving replied service information and recording this in a service information recording file 45. Furthermore, there is provided a data input/output section 47 for inserting information of the client ID or password in data which is sent through the client administration section 42, and a card reader-writer 48. The data input/output section 47 and the card reader-writer 48 are however an option for the user terminal 103, for performing card operations.

Next is a description of the operation of the user terminal 103 with reference to the drawings. The user terminal 103 has the following four functions.

(1) New card issue.

(2) Card reissue.

(3) Retrieval of card use state.

(4) Retrieval of service information from client.

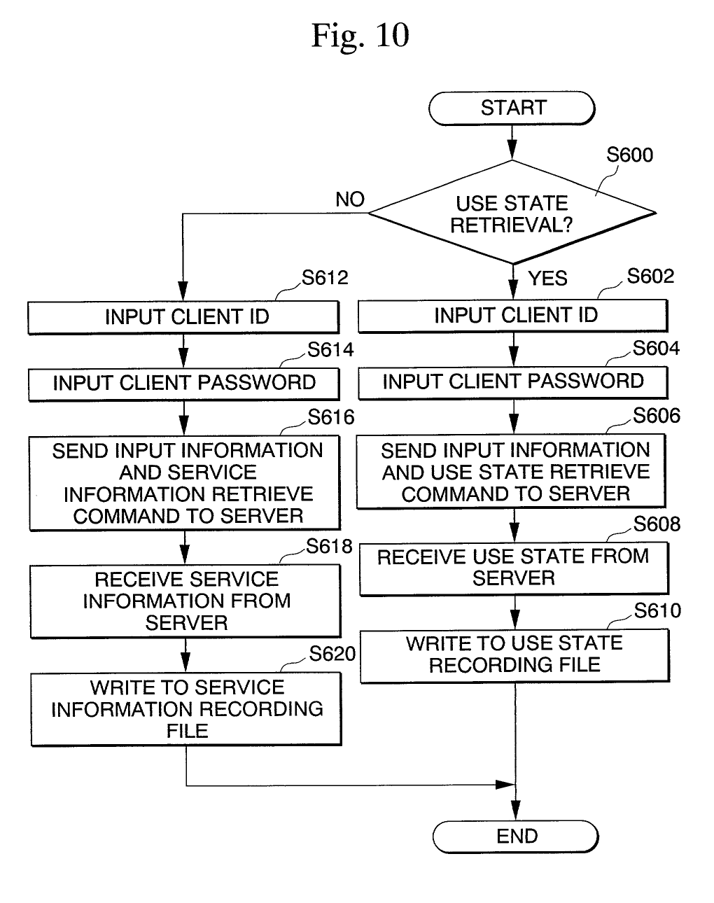

The flow related to the abovementioned functions of (1) and (2) is the same as for the operation in the shop terminal 102 shown in FIG. 7, and hence description is here omitted. FIG. 10 is a flow chart for explaining the retrieval operation of the user terminal 103, describing the functions of the abovementioned (3) and (4).

At first, the client administration section 42, when there is a request for retrieval, judges if this is for retrieval of use state (step S600).

If the request is for retrieval of use state (step S600: YES), the client administration section 42 inputs the client ID (step S602).

Next, the password of the client is input (step S604). Once the password has been input, the use state retrieval section 44 sends the input information and the use state retrieve command to the client administrative server 101 through the client administration section 42 (step S606).

If as a response to this, the use state is received from the client administrative server 101 (step S608), the client administration section 42 writes the received use state to the use state recording file 43 through the use state retrieval section 44, and control ends (step S610).

Furthermore, in the case where the request in step S600 is not for retrieval of use state (step S600: NO), the client administration section 42 assumes that service information retrieval has been requested, and at first inputs the client ID (step S612).

Next, the password of the client is input (step S614).

Once the password has been input, the service information retrieval section 46 sends the input information and the service information retrieve command to the client administrative server 101 through the client administration section 42 (step S616).

If as a response to this, the service information is received from the client administrative server 101 (step S618), the client administration section 42 writes the received service information to the service information recording file 45 through the service information retrieval section 46, and control ends (step S620).

In the above described embodiments, the private information DB 3, the purchase history DB 5, the service point DB 7 , the service information DB 9, the service rule DB 23, the client information recording file 29, the use state recording file 43 and the service information recording file 45 provided in the client administrative server 101, the shop terminal 102 and the user terminal 103 are devices constructed from a hard disc or a magneto-optical disc, a non volatile memory such as a flash memory, a recording medium capable of read only such as a CD-ROM, a volatile memory such as a RAM (Random Access Memory), or a computer readable and writeable recording medium comprising a combination of these, or are information recorded on these.

Furthermore, the communication sections 1, 21 and 41, the client response recognition section 2, the private information administration section 4, the purchase history administration section 6, the service point administration section 8, the service information administration section 10, the service information transmission section 11, the client administration sections 22 and 42, the service point administration section 24, the point information creation section 25, the purchase history creation section 26, the purchased product input section 27, the client information retrieval section 28, the data input/output sections 30 and 47, the use state retrieval section 44, and the service information retrieval section 46 provided in the client administrative server 101, the shop terminal 102 and the user terminal 103 may be realized by dedicated hardware. Moreover, these may be constituted by a memory and a CPU (Central Processing Unit), and the functions of the abovementioned respective sections may be realized by loading and executing a program for realizing these functions into memory.

Furthermore, an input device, a display and so forth (none shown in the figure) are connected to the client administrative server 101, the shop terminal 102 and the user terminal 103 as peripheral equipment. Here an input device is an input unit such as a keyboard and mouse. A display is a device such as a CRT (Cathode Ray Tube) or liquid crystal display.

Furthermore, a program for realizing the functions of the abovementioned client administrative server 101, the shop terminal 102 and the user terminal 103 may be recorded on a computer readable recording medium, and the member card administration system then constructed by reading in the program recorded on this recording medium, into a computer system and executing the program.

Here the abovementioned “computer system” includes the operating system and hardware such as peripheral equipment. Furthermore, in the case where the WWW (World Wide Web) system is used, this also includes the home page provider environment (or display environment). Moreover, “a computer readable recording medium” means a portable medium such as a floppy disc, a magneto-optical disc, a ROM, a CD-ROM, or a storage device such as a hard disc incorporated into a computer system. Furthermore, “a computer readable recording medium” also includes a medium (transmission medium or transmission waves) which dynamically retains a program during a short time such as when a program is transmitted via a network such as the Internet or via a communication line such as a telephone line, and a medium which retain a program for a fixed time such as a volatile memory inside a computer system which constitutes the server or client for that case.

Moreover, the abovementioned program may be one for realizing a part of the aforementioned functions. In addition, this may be one which is realized in combination with a program where the aforementioned functions are already recorded on a computer system, or may be a so called difference file (difference program).

With the present invention as described above, in a client administrative server used in a member card administration system which uses a rewritable card, there is provided; a communication device for sending and receiving data via a computer network, a private information administration device for recording and administering in a private information database, private information of clients containing client ID, contained in data received by the communication device, and a service point administration device for relating service point information of clients contained in data received by the communication device to client information and shop information, and recording and administering this in a service point database.

As a result, private information of a client, and the service points of the client can be administered together as one. Therefore, it is sufficient if the client holds one member card, effectively releasing the client from the heretofore troublesome situation where they must properly use a plurality of member cards. Furthermore, even if the card is lost, since the information is kept in the client administrative server, there is the effect that the record of service points etc. up until then is not lost. Moreover, since the private information of the client is centrally administered at one place, there is the effect that the risk of leaking out to another party can be kept to a minimum.

Furthermore, with the present invention, in the client administrative server, there is provided a purchase history administration device for relating purchase history information of clients contained in data received by the communication device to client information and recording and administering this in a purchase history database.

As a result, the preferences and lifestyle of a client can be understood from the information accumulated in the client administrative server.

Furthermore, with the present invention, in the client administrative server, there is provided a service information administration device for relating service information of shops contained in data received by the communication device to shop information, and recording and administering this in a service information database.

As a result, service information for each shop can be efficiently provided to the client.

Therefore, the shop side which can understand the preference of the client, can administer products and services to match these all together, with the effect that these can be effectively provided to the client.

Moreover, with the present invention, in the client administrative server, there is provided a service information generation device for selecting recorded contents of the service information database using product information stored in the purchase history database, and creating and transmitting service information for each client to an address recorded in the private information database.

As a result, service information combined with client preferences can be automatically sent to the client. Hence there is the effect that the amount of work on the shop side can be reduced.

Moreover, with the present invention, in the client administrative server, the private information administration device compares a client password contained in data received by the communication device with a client password recorded in the private information database, with respect to a reissue command for a service card, and in the case where both match, transmits a reissue permit command.

As a result, if the client acquires only a rewritable card, it is possible to reissue a service card. Hence there is the effect that there is no longer the heretofore need to worry about other things apart from the requirements for administration of the service card.

Furthermore, with the present invention in the shop terminal which is connectable by communication to any of the abovementioned client administrative servers, there is provided; a communication device for sending and receiving data via a computer network, a data input device for inputting information of client ID and password to a user, a purchased product input device for inputting information of products which a client has bought to a user, a service rule administration device for administering information showing a proportion of points to purchased amount recorded in a service rule database, a purchase history creation device for creating purchase history information of products which a client has bought from product information input to the purchased product input device, a point information creation device for creating service point information corresponding to the purchased amount of products which a client has bought, based on the proportion of points to purchased amount recorded in the service rule database, and a client administration device for sending together with the client ID and password, the purchase history information and the service point information, and also shop ID by means of the communication device.

As a result, a member shop can accumulate information of a client in a client administrative server. Hence there is the effect that a wide range of information concerning the client but not related to the location or type of business of the member shop is collected.

Furthermore, with the present invention, in the shop terminal there is provided a card read and write device capable of reading out a client ID from the rewritable card at the time of service card use, and writing a client ID to the rewritable card at the time of service card reissue.

As a result, a member shop can easily perform issue and administration of client service cards. Therefore there is the effect that the client can use a service for the same rewritable card at any member shop, and reissue of a card when lost is easily performed.

Furthermore, with the present invention, in the shop terminal there is provided a client information retrieval device for transmitting a client information retrieve command by the communication device, and receiving replied client information and recording this in a client information recording file.

As a result, a member shop can acquire information of a client freely from the client administrative server. Therefore there is the effect that a strategy directed to sales promotion of the shop itself can be designed.

Moreover, with the present invention a user terminal which is connectable by communication to any of the abovementioned client administrative servers, is provided with; a communication device for sending and receiving data via a computer network, a data input device for inputting information of client ID or password to a user, a use state retrieval device for sending a use state retrieve command together with the client ID or password, and receiving a replied use state, and recording this in a use state recording file, and a service information retrieval device for sending a service information retrieve command together with the client ID or password, and receiving replied service information, and recording this in a service information recording file.

As a result, a client can acquire a use state of their own service points, or service information for each shop, freely from the client administrative server. Therefore there is the effect that the client can have a plan for purchase of a product at the same shop.

With the present invention, in the user terminal, instead of the data input device, there is provided a card read and write device capable of reading out a client ID from the rewritable card at the time of service card use, and writing a client ID to the rewritable card at the time of service card reissue.

As a result, a client can perform an operation with respect to the service card, even if outside of a member shop. Therefore in the case of a lost card or the like, there is no longer the requirement to set off expressly to the shop. Furthermore, there is the effect that a service card can be used in virtual shopping on the Internet.

What is claimed is:

1. A client administrative server used in a member card administration system which uses a rewritable card, said server comprising;
communication means for sending and receiving data via a computer network,
private information administration means for recording and administering in a private information database, private information of clients containing client ID, contained in data received by said communication means, and
service point administration means for relating service point information of clients contained in data received by said communication means to client information and shop information, and recording and administering this in a service point database.

2. A client administrative server according to claim 1, wherein there is provided purchase history administration means for relating purchase history information of clients contained in data received by said communication means to client information and recording and administering this in a purchase history database.

3. A client administrative server according to claim 1, wherein there is provided service information administration means for relating service information of shops contained in data received by said communication means to shop information, and recording and administering this in a service information database.

4. A client administrative server according to claim 1, wherein there is provided service information generation means for selecting recorded contents of said service information database using product information stored in said purchase history database, and creating and transmitting service information for each client to an address recorded in said private information database.

5. A client administrative server according to claim 1, wherein said private information administration means compares a client password contained in data received by said communication means with a client password recorded in said private information database, with respect to a reissue command for a service card, and in the case where both match, transmits a reissue permit command.

6. A shop terminal which is connectable by communication to a client administrative server according to claim 1, comprising;
communication means for sending and receiving data via a computer network,
data input means for inputting information of client ID and password to a user,
purchased product input means for inputting information of products which a client has bought to a user,
service rule administration means for administering information showing a proportion of points to purchased amount recorded in a service rule database,
purchase history creation means for creating purchase history information of products which a client has bought from product information input to said purchased product input means,
a point information creation means for creating service point information corresponding to the purchased amount of products which a client has bought, based on the proportion of points to purchased amount recorded in said service rule database, and
client administration means for sending together with said client ID and password, said purchase history information and said service point information, and also shop ID by means of said communication means.

7. A shop terminal according to claim 6, wherein there is provided card read and write means capable of reading out a client ID from said rewritable card at the time of service card use, and writing a client ID to said rewritable card at the time of service card reissue.

8. A shop terminal according to claim 6, wherein there is provided client information retrieval means for transmitting a client information retrieve command by said communication means, and receiving replied client information and recording this in a client information recording file.

9. A user terminal which is connectable by communication to a client administrative server according to claim 1 comprising;
communication means for sending and receiving data via a computer network,
data input means for inputting information of client ID or password to a user,
use state retrieval means for sending a use state retrieve command together with said client ID or password, and receiving a replied use state, and recording this in a use state recording file, and
service information retrieval means for sending a service information retrieve command together with said client ID or password, and receiving replied service information, and recording this in a service information recording file.

10. A user terminal according to claim 9, wherein instead of said data input means, there is provided card read and write means capable of reading out a client ID from said rewritable card at the time of service card use, and writing a client ID to said rewritable card at the time of service card reissue.

11. A member card administration system which uses a rewritable card, connected via a computer network, and containing;
a client administrative server according to claim 1,
a shop terminal according to claim 6, and
a user terminal according to claim 9.

12. A member card administration method, which uses a rewritable card wherein, a client administrative server side contains;
a communication process for sending and receiving data via a computer network,
a process for recording and administering private information of clients which contains client ID, contained in data received by said communication means, in an private information database, and
a process for relating service point information of clients contained in data received by said communication means to client information and shop information, and storing and administering this in a service point database, and a shop terminal side contains;
a communication process for sending and receiving data via a computer network,
a process for inputting information of client ID and password to a user,
a process for inputting information of products which a client has bought to a user,
a process for administering information showing a proportion of points to purchased amount stored in a service rule database,
a process for creating purchase history information of products which a client has bought from product information input to said purchased product input means,
a process for creating service point information corresponding to purchased amount of products which a client has bought based on a proportion of points to purchased amount recorded in said service rule database, and
a process for sending together with said client ID and password, said purchase history information and said service point information, and also shop ID, and a user terminal side contains;
a communication process for sending and receiving data via a computer network,
a process for inputting information of client ID or password to a user,
a process for sending a use state retrieve command together with said client ID and password, and receiving a replied use state and recording this in a use state recording file, and
a process for sending a service information retrieve command together with said client ID or password, and receiving replied service information and recording this in a service information recording file.

13. A computer readable recording medium recorded with a program for a client administrative server side used in member card administration which uses a rewritable card, wherein said program comprises:
a communication process for sending and receiving data via a computer network,
a process for recording and administering private information of clients which contains client ID, contained in data received by said communication means, in a private information database, and
a process for relating service point information of clients contained in data received by said communication means to client information and shop information, and recording and administering this in a service point database.

14. A computer readable recording medium recorded with a program for a shop terminal side used in member card administration which uses a rewritable card, wherein said program comprises:
a communication process for sending and receiving data via a computer network,
a process for inputting information of client ID and password to a user,
a process for inputting information of products which a client has bought to a user,
a process for administering information showing a proportion of points to purchased amount recorded in a service rule database,
a process for creating purchase history information of products which a client has bought from product information input to said purchased product input means,
a process for creating service point information corresponding to the purchased amount of products which a client has bought, based on the proportion of points to purchased amount recorded in said service rule database, and
a process for sending together with said client ID and password, said purchase history information and said service point information, and also shop ID.

15. A computer readable recording medium recorded with a program for a user terminal side used in member card administration which uses a rewritable card, wherein said program comprises:
a communication process for sending and receiving data via a computer network,
a process for inputting information of client ID or password to a user,
a process for sending a use state retrieve command together with said client ID or password, and receiving a replied use state and recording this in a use state recording file, and
a process for sending a service information retrieve command together with said client ID or password, and receiving replied service information and recording this in a service information recording file.
